(19) United States
(12) Patent Application Publication
(10) Pub. No.: US 2026/0016438 A1
(43) Pub. Date: Jan. 15, 2026

(54) AIRFLOW DETECTION BY CAPACITANCE

(71) Applicant: Microchip Technology Incorporated, Chandler, AZ (US)

(72) Inventors: Patrick McFarland, Gilbert, AZ (US); Arthur B. Eck, Gilbert, AZ (US)

(73) Assignee: Microchip Technology Incorporated, Chandler, AZ (US)

(21) Appl. No.: 18/893,325

(22) Filed: Sep. 23, 2024

Related U.S. Application Data
(60) Provisional application No. 63/671,452, filed on Jul. 15, 2024.

(51) Int. Cl. G01N 27/22

(52) U.S. Cl. CPC G01N 27/228; G01N 27/226

(57) ABSTRACT

Some examples of the teachings herein include a system comprising: a first housing defining an internal test chamber; a plurality of passageways allowing air flow into the internal test chamber; a first capacitance detector to measure a first air capacitance outside the internal test chamber; a second capacitance detector to measure a second air capacitance inside the internal test chamber; and a processor to compare a first signal output from the first capacitance detector to a second signal output from the second capacitance detector and identify any lag between a change in the first signal and a corresponding change in the second signal.

### PRIORITY STATEMENT

This application claims priority to U.S. Provisional Patent Application No. 63/671,452 filed Jul. 15, 2024, the contents of which are hereby incorporated in their entirety.

### TECHNICAL FIELD

The present disclosure relates to monitors. Various examples of the teachings herein include systems and/or methods for detecting airflow in a test chamber.

### BACKGROUND

Typical smoke detectors employ a light sensor and measure light reflected off of smoke particles. This may include generating light in one part of the smoke detector and measuring it in another. Extraneous light impinging on the light sensor may interfere with accurate sensing. To avoid this, typical smoke detectors include a housing with baffles allowing smoke particles to enter a test chamber but reducing the entry of any external light.

In the field of electronic devices, e.g. monitors and sensors, a build-up of dust and debris may adversely affect the operation thereof. For example, such build-up may reduce the accuracy of sensor readings and the effectiveness of a monitor. The operation of environmental sensors such as smoke detectors and other life safety monitors may be compromised. In a housing with baffles, dust and debris may impede the travel of smoke particles into the test chamber or even block them completely.

For the purposes of this disclosure, a monitoring system refers to an electronic device which monitors one or more conditions, such as a smoke detector or a thermostat. A sensor or sensor element refers to a specific element within such a monitoring system to detect a particular parameter or condition.

### BRIEF DESCRIPTION OF THE DRAWINGS

FIG. 1 illustrates an example system incorporating teachings of the present disclosure;

FIG. 2 illustrates an exploded view of the system shown in FIG. 1;

FIG. 3 illustrates a further exploded view of the system shown in FIG. 1;

FIG. 4 illustrates example components of the system shown in FIG. 1; and

FIG. 5 illustrates a detailed view of some components of the system shown in FIG. 1.

### DETAILED DESCRIPTION

The teachings of the present disclosure may allow an indirect measurement of air travel through the baffles of a housing. In some examples, the housing of a monitoring system may include a device to measure the capacitance of the air within the housing and/or test chamber. An equivalent device measures the capacitance of room air-air that is not impeded by any baffles or a narrow passageway. If the humidity and/or temperature of the room air change, the air capacitance of the room air will change correspondingly. The air inside the housing and/or test chamber, however, may have a delayed change due to any resistance in the baffles or passageways caused by dust and/or debris.

A delayed change between the two capacitance measures may indicate restricted and/or blocked passageways. The monitor system may include an alert or alarm indicating blocked passageways and or a call to replace the housing or baffle system. Such a self-monitoring monitor system may reduce and/or eliminate periodic testing by a technician.

Some alternative self-monitoring systems include flash LEDs (light emitting diodes) arrayed around the chamber. These LEDs are triggered to measure light leakage. Such an LED-driven system includes increased costs to the monitor system including the LEDs themselves, devices to power and drive the LEDs, and a power supply to handle the surge resulting from such testing. An air capacitance testing system as described herein requires significantly less energy and significantly less up-front cost for the elements of the system in comparison to an LED system.

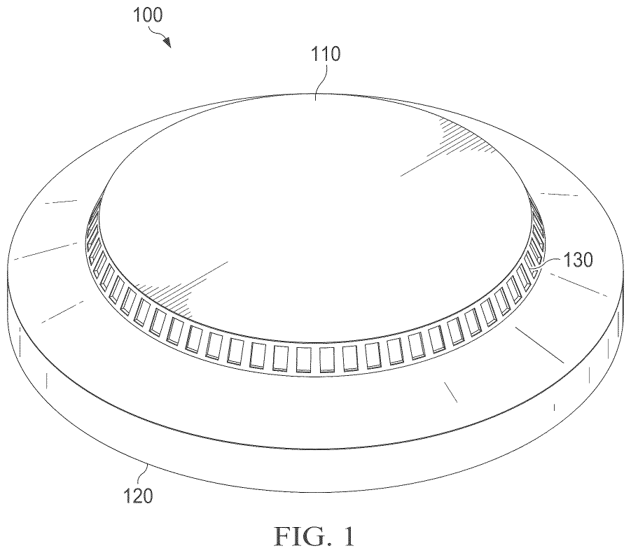

FIG. 1 illustrates an example monitoring system 100 incorporating teachings of the present disclosure. The monitoring system 100 includes an external housing top 110, an external housing bottom 120, and vents 130 allowing fluid flow into an interior defined between the external housing top 110 and the external housing bottom 120.

The monitoring system 100 may include a monitor, e.g., a smoke detector. In the example shown in FIG. 1, the monitoring system 100 may include an external housing bottom 120 to mount the monitoring system 100 to a wall or ceiling. In practice, the external housing bottom 120 may be mounted at the top of the monitoring system 100, e.g., mounted to the ceiling so the external housing top 110 actually hangs from the external housing bottom 120. The terms “top” and “bottom” are used relative to the orientation shown in FIG. 1 but do not limit the use of the components in practice.

As shown in FIG. 1, the external housing top 110 includes vents 130 to allow fluid flow into an interior space of the system 100. In practice, vents 130 may be in any part of the housing, including external housing bottom 120, or both. In practice, vents 130 may be defined between two parts of the external housing.

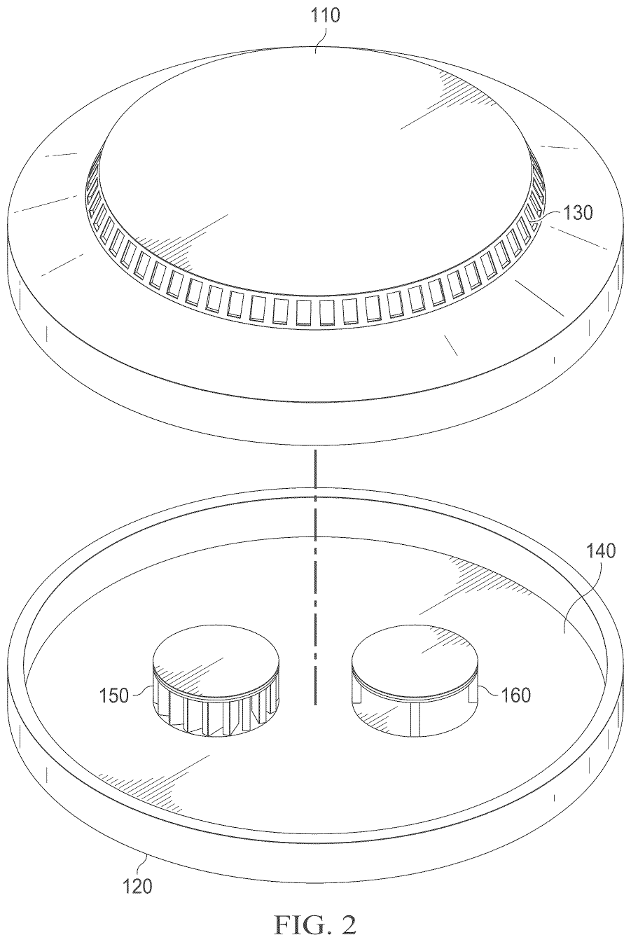

FIG. 2 illustrates an exploded view of the monitoring system 100. As shown in FIG. 2, the external housing top 110 and the external housing bottom 120 may be separate parts defining an interior. The monitoring system 100 includes a printed circuit board (PCB) 140. PCB 140 provides a mounting surface for a first housing 150 defining a baffled chamber and a second housing 160 defining an open chamber. In some monitoring systems, there may be a mounting surface that is not a PCB. For example, the first housing 150 and the second housing 160 may be mounted directly to either the external housing top 110 or the external housing bottom 120. As another example, the first housing 150 and the second housing 160 may be mounted to different elements of the system.

PCB 140 may include circuitry or leads to provide power and/or signals to components of the first housing 150 and/or the second housing 160. As an example, a processor may be mounted to the PCB 140 and connected to the first housing 150 by printed circuits or conductive tracks on the PCB 140.

As shown, the first housing 150 defines an internal test chamber for the monitoring system 100. When the monitoring system 100 comprises a smoke detector, the internal test chamber may comprise a baffled chamber deflecting some or all ambient light from outside the system 100, providing a dark test chamber for a photochamber-style smoke detector. The baffles may become occluded with dust or other debris over time.

In some examples, the monitoring system 100 includes a device to measure the capacitance of the air within the test chamber defined by the first housing 150. An equivalent device measures the capacitance of room air represented in the open chamber defined by the second housing 160—air that is not significantly impeded by baffles or narrow passageways. If the humidity and/or temperature of the room air changes, the air capacitance of the open chamber will change correspondingly. The air inside the test chamber, however, may have a delayed change due to accumulated blockage or resistance in the baffles or passageways caused by dust and/or debris.

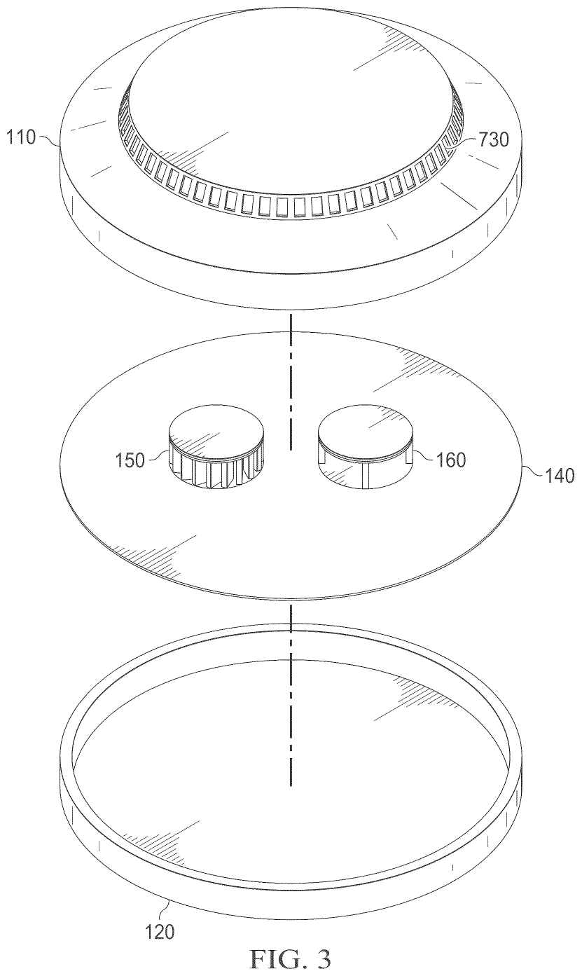

FIG. 3 illustrates a further exploded view of the monitoring system 100 wherein the PCB 140 is separated from the external housing 110/120.

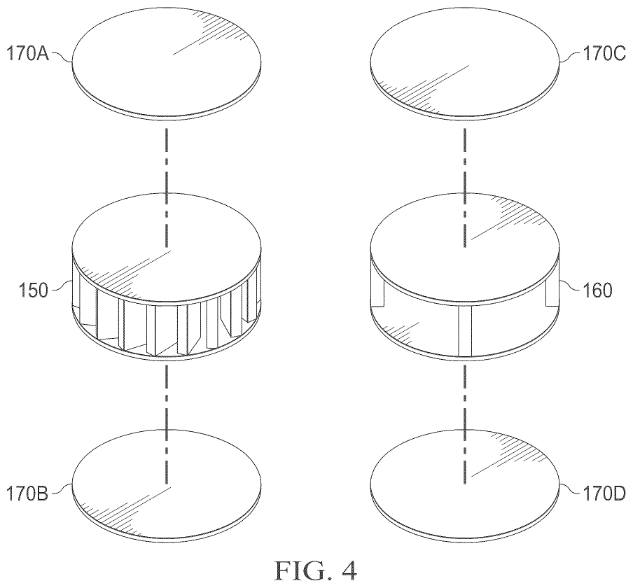

FIG. 4 illustrates example components of the monitoring system 100. As shown in FIG. 4, the monitoring system 100 further comprises plates 170a, 170b, 170c, and 170d. First plates 170a and 170b are mounted to opposing sides of the first housing 150. Second plates 170c and 170d are mounted to opposing sides of the second housing 160. In this example, the monitoring system 100 operates to measure a first air capacitance between first plates 170a and 170b and a second air capacitance between second plates 170c and 170d. In this example, the plates are matched in size and material, which may simplify comparison of the two capacitance values. As shown in FIG. 4, the second housing 160 is mounted inside the external housing 110/120. In some monitoring systems, however, the second housing 160 may be mounted outside the external housing 110/120. In some monitoring systems, there may be three or more capacitance detectors, including one for the test chamber, one inside the external housing, and one outside the external housing.

In some examples, the relevant dimensions of the first housing 150 and the second housing 160 are also matched, including the diameters and the height of the housing so the space defined between the relevant plates matches. In some examples, however, the sizes or material may be different and the measured air capacitance values will vary based on the relevant ratios of the dimensions.

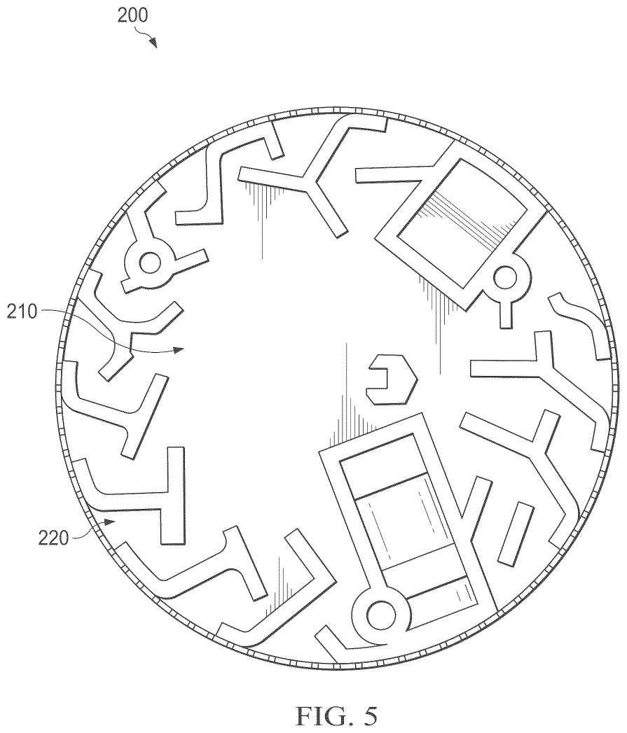

FIG. 5 illustrates a detailed view of some components of an example monitoring system 200 incorporating teachings of the present disclosure. In the example shown, the monitoring system 200 includes a first housing defining a test chamber 210 and a plurality of passageways 220.

The first housing may include any combination of inlets or outlets appropriate for allowing air flow into the test chamber 210. As shown in FIG. 5, the plurality of passageways 220 may include baffles configured to allow air flow (along with any entrained particles) into the test chamber 210 while restricting and/or blocking the entrance of light from outside the monitor system 200.

The monitoring system 200 may include one or more sensor elements which may be mounted to operated inside the test chamber 210. The sensor elements may monitor any appropriate parameter and may operate under any appropriate scheme, including without limitation by measuring a capacitance, a current, a resistance, etc. In some examples, the monitoring system 200 comprises a photochamber-style smoke detector. In such examples, the monitoring system 200 includes one or more light emitting diodes (LEDs) and one or more photodiodes operating to detect particles in the air inside the test chamber 210.

The one or more sensor elements may be exposed to any air flow within the test chamber 210 and may, therefore, depend on air flow through the plurality of passageways 220. In such a case, any blockage or impediment to air flow through the plurality of passageways 220 may reduce the accuracy and/or efficiency of the monitor system 100. Using the systems and/or methods described herein may allow a user to provide a monitoring system 200 operable to check itself for proper air flow into the internal test chamber 210. If the monitoring system 200 detects impeded air flow into the internal test chamber, the monitoring system 200 may provide an alert, an alarm, or any other sort of communication indicating the condition for repair, replacement, or other maintenance activity. In some examples, the monitoring system 200 may include some form of self-cleaning apparatus and may trigger said apparatus in response to determining air flow is impeded.

We claim:

1. A system comprising:
a first housing defining an internal test chamber;
a plurality of passageways allowing air flow into the internal test chamber;
a first capacitance detector to measure a first air capacitance outside the internal test chamber;
a second capacitance detector to measure a second air capacitance inside the internal test chamber; and
a processor to compare a first signal output from the first capacitance detector to a second signal output from the second capacitance detector and identify any lag between a change in the first signal and a corresponding change in the second signal.

2. A system as recited in claim 1, further comprising an external housing surrounding the first housing, the first capacitance detector, the second capacitance detector, and the processor.

3. A system as recited in claim 1, further comprising:
an external housing surrounding the first housing, the first capacitance detector, the second capacitance detector, and the processor; and
a printed circuit board (PCB) mounted to an interior of the external housing;
wherein the first housing, the first capacitance detector, the second capacitance detector, and the processor are mounted on the PCB.

4. A system as recited in claim 1, wherein:
the first capacitance detector includes two metal plates on opposite sides of the first housing; and
the first signal corresponds to a capacitance between the two metal plates.

5. A system as recited in claim 1, wherein:
the first capacitance detector includes two first metal plates on opposite sides of the first housing;
the first signal corresponds to a first capacitance between the two first metal plates;
the second capacitance detector includes two second metal plates on opposite sides of a second housing; and
the second signal corresponds to a second capacitance between the two second metal plates.

6. A system as claimed in claim 5, wherein the first housing and the second housing comprise matching dimensions and material.

7. A system as claimed in claim 1, wherein:
the first capacitance detector includes two first metal plates on opposite sides of the first housing;
the first housing includes baffles restricting fluid flow into the internal test chamber;
the first signal corresponds to a first capacitance between the two first metal plates;
the second capacitance detector includes two second metal plates on opposite sides of a second housing;
the second housing allows fluid flow into an interior space without baffles; and
the second signal corresponds to a second capacitance between the two second metal plates.

8. A system as recited in claim 1, further comprising:
an external housing surrounding the first housing, the first capacitance detector, the second capacitance detector, and the processor; and
a printed circuit board (PCB) mounted to an interior of the second housing;
wherein the first housing, the first capacitance detector, the second capacitance detector, and the processor are mounted on the PCB;
wherein the first capacitance detector includes two first metal plates on opposite sides of the first housing;
the first housing includes baffles restricting fluid flow into the internal test chamber;
the first signal corresponds to a first capacitance between the two first metal plates;
the second capacitance detector includes two second metal plates on opposite sides of a second housing;
the second housing allows fluid flow into an interior space without baffles; and
the second signal corresponds to a second capacitance between the two second metal plates.

9. A method for operating a monitoring system, the method comprising:
detecting a first capacitance of air inside a test chamber of the monitoring system;
detecting a second capacitance of air outside a test chamber of the monitoring system;
comparing a first signal representing the first capacitance to a second signal representing the second capacitance; and
identifying restricted air flow into the test chamber if there is a lag between a change in the first signal and a corresponding change in the second signal.

10. A method as recited in claim 9, wherein the monitoring system comprises:
an external housing surrounding a first housing, a first capacitance detector, a second capacitance detector, and a processor;
wherein the external housing includes vents allowing fluid flow to reach the first housing;
the first capacitance detector generates the first signal; and
the second capacitance detector generates the second signal.

11. A method as recited in claim 9, wherein the monitoring system comprises:
an external housing surrounding a first housing, a first capacitance detector, a second capacitance detector, and a processor; and
a printed circuit board (PCB) mounted to an interior of the external housing;
wherein the first housing, the first capacitance detector, the second capacitance detector, and the processor are mounted on the PCB.

12. A method as recited in claim 10, wherein:
a first capacitance detector including two metal plates on opposite sides of the first housing generates the first signal; and
the first signal corresponds to a capacitance between the two metal plates.

13. A method as recited in claim 9, wherein:
a first capacitance detector includes two first metal plates on opposite sides of a first housing defining the test chamber;
the first signal corresponds to a first capacitance between the two first metal plates;
a second capacitance detector includes two second metal plates on opposite sides of a second housing; and
the second signal corresponds to a second capacitance between the two second metal plates.

14. A method as claimed in claim 13, wherein the first housing and the second housing comprise matching dimensions and material.

15. A method as claimed in claim 9, wherein:
a first capacitance detector includes two first metal plates on opposite sides of a first housing defining the test chamber;
the first housing includes baffles restricting fluid flow into the test chamber;
the first signal corresponds to a first capacitance between the two first metal plates;
a second capacitance detector includes two second metal plates on opposite sides of a second housing;
the second housing allows fluid flow into an interior space without baffles; and
the second signal corresponds to a second capacitance between the two second metal plates.

16. A method as recited in claim 9, wherein:
an external housing surrounds a first housing, the first capacitance detector, the second capacitance detector, and a processor; and
a printed circuit board (PCB) is mounted to an interior of the external housing;
wherein the first housing, the first capacitance detector, the second capacitance detector, and the processor are mounted on the PCB;
wherein the first capacitance detector includes two first metal plates on opposite sides of the first housing;
the first housing includes baffles restricting fluid flow into the internal test chamber;
the first signal corresponds to a first capacitance between the two first metal plates;
the second capacitance detector includes two second metal plates on opposite sides of a second housing;
the second housing allows fluid flow into an interior space without baffles; and
the second signal corresponds to a second capacitance between the two second metal plates.

17. A method as recited in claim 9, wherein:
the monitoring system includes a housing surrounding the test chamber; and
the air outside the test chamber comprising air outside the housing.

18. A system comprising:
a first housing defining an internal test chamber;
a second housing surrounding the first housing;
a plurality of passageways allowing air flow into the internal test chamber;
a first capacitance detector arranged outside the second housing to measure a first air capacitance;
a second capacitance detector to measure a second air capacitance inside the internal test chamber; and
a processor to compare a first signal output from the first capacitance detector to a second signal output from the second capacitance detector and identify any lag between a change in the first signal and a corresponding change in the second signal.

19. A system as recited in claim 18, further comprising a third capacitance detector to measure a third air capacitance, the third capacitance detector arranged outside the first housing and within the second housing;
wherein the processor monitors a third signal output from the third capacitance detector to identify any lag between the change in the first signal, the change in the second signal, and a corresponding change in the third signal.
